(19) United States
(12) Patent Application Publication
(10) Pub. No.: US 2008/0167806 A1
(43) Pub. Date: Jul. 10, 2008

(54) SYSTEM AND METHOD FOR PROVIDING LOCAL MAPS USING WIRELESS HANDHELD DEVICES

(75) Inventors: Lorraine Wheeler, Billerica, MA (US); Michael Vosseller, Somerville, MA (US); Rob Podoloff, Framingham, MA (US)

Correspondence Address: FISH & RICHARDSON, PC, P.O. BOX 1022, MINNEAPOLIS, MN, 55440-1022, US

(73) Assignee: Zeetoo, Inc.

(21) Appl. No.: 11/620,604

(22) Filed: Jan. 5, 2007

(51) Int. Cl. G01C 21/34; G01S 5/00

(52) U.S. Cl. 701/208; 340/932.2

(57) ABSTRACT

A system and method of automatically providing a local map on a wireless handheld device based on a vehicle location in response to a triggering signal enables a user to immediately access the local map by generating an activating signal, such as one generated from the press of a button on the wireless handheld device, to assist the user in finding her final destination or to later access the local map to find her vehicle. The triggering signal may be in response to the user manually or remotely turning off the vehicle's ignition or locking the vehicle. Once the triggering signal is received, the location of the vehicle and local map information associated with the vehicle's location can be automatically stored on the user's wireless handheld device. The local map information forms the basis for the local map.

This application is related to co-pending U.S. patent application Ser. No. 11/519,446, filed on Sep. 11, 2006 and entitled “Location Tracking System.” The contents of the U.S. patent application Ser. No. 11/519,446 are incorporated in its entirety by reference.

### BACKGROUND

The subject matter described herein relates to systems and methods for providing local maps on a wireless handheld device based on a vehicle's location which can then be used by a person, e.g., to find her final destination or to later locate the vehicle.

Most people lead hectic lives and often need assistance to find where their desired destination is located, whether it is a particular restaurant, a business, a movie theater, a shopping mall or even an acquaintance's home. To get there, most people travel by vehicle (such as a car, truck, motorcycle, scooter, bicycle or boat). But due to such hectic lives and crowded conditions, often times these people have to park far from their final destination and therefore must walk the remaining distance to reach their final destination. Because of that, people tend to forget where they parked their vehicle.

Systems are currently available to help people find their final destination. For example, many conventional wireless handheld devices (e.g., cellular phone handsets) have Internet access, which a user can use to obtain local maps via the Internet using Internet websites such as Google™ Maps and Mapquest™, both of which provide downloadable local maps based on, for example, an entered zip code or a street address. In addition to having Internet access, some conventional wireless handheld devices can obtain location based data from a Global Positioning System (GPS), which have been used to provide point to point directions from where the user is with the cellular phone to the user's final destination. Typically, the response time to achieve a first GPS location signal is time consuming, so users may have to wait up to several minutes before they can capture their current location, in addition to the time spent to enter the address or zip code into the wireless handheld device after accessing the Internet to obtain a local map.

Systems are also currently available to help people later find their vehicle. For example, conventional key fobs (e.g., remotes for keyless entry systems) have been used to assist users to locate “lost” vehicles in a parking lot. Such key fobs require the user to activate a “panic” button on the key fob within a certain limited range to produce a loud auditory signal from an alarm or a horn located in the vehicle. Assuming such a user is not hearing-impaired, the user can then locate her vehicle based on the source of the auditory signal.

### SUMMARY

The present inventors recognized that currently available systems do not provide an easy way to help users mark the location of their previously parked vehicle, locate their current position, and help the users find their way back to their parked vehicle. Moreover, the present inventors recognized that conventional systems for assisting a user to find a final destination typically are inefficient, precisely at the moment when the user needs immediate directions to the final destination. For example, to load a local map onto a wireless handheld device, the user typically has to wait for the handheld device to access the Internet, and then spend additional time to manually enter the address of the final destination using a variety of text entry methods available on the phone, all of which are slow and cumbersome for entering mixed text and numbers such as may appear in an address string. Bringing up a local map alone could take several minutes. If the user has a phone equipped with GPS and associated navigational software on the phone, she would typically have to wait several additional minutes for the GPS chip in the mobile phone to obtain a first location reading, in order to provide point to point directions from where the user is with the mobile phone to the final destination.

The present inventors also recognized that conventional systems for assisting users to find their way back to their vehicle (e.g., key fobs) are limited in that they have limited range and are typically not useful unless the users are already close to their vehicle. Moreover, the loud audible noise that emanates from the vehicle when such a system is used is annoying and can lead to embarrassment for the users. Additionally, such systems are not useful to hearing-impaired users. Furthermore, while an audible alarm is of some use in locating the general location of a parked car, it is not precise in its indication of location, and can be of limited use in a very large parking lot where the car emitting the alarm is not immediately visible by line of sight. One might proceed to the right section and yet fail to locate the correct aisle in which the vehicle is parked. Consequently, the present inventors developed the subject matter described herein, which, for example, automatically provides a local map on a wireless handheld device based on a vehicle's location, such as where it is parked in a parking garage or on the street, with particular care given to providing a fast and interactive user experience that requires no significant changes of behavior in the users' habits of locking their vehicle, or their normal usage patterns for their handheld devices.

In one implementation, a method of providing a map on a wireless handheld device includes receiving a triggering signal and determining a vehicle location in response to the triggering signal. The method also includes storing the vehicle location and providing map information based on the stored vehicle location. Other implementations of this aspect include corresponding systems, apparatus, and computer program products.

In another implementation, a system for providing a map associated with a vehicle location can include a wireless handheld device including a computer readable medium. The system can also include a computer program product stored on the computer readable medium, the stored computer program product including executable instructions causing the wireless handheld device to receive a triggering signal. The executable instruction can also cause the wireless handheld device to determine the vehicle location in response to the triggering signal and store the vehicle location, and further cause the wireless handheld device to provide map information based on the stored vehicle location.

Variations to these implementations may include one or more of the following features. For example, the method of providing a map on a wireless handheld device can include receiving an activating signal and retrieving the map information in response to the activating signal. The method can also include displaying a graphical user interface (GUI). The displaying of the GUI can include rendering a map based on the map information and rendering a first GUI element associated with the stored vehicle location. The displaying of the GUI can also include determining a current location of the wireless handheld device and rendering a second GUI element associated with the determined current location. The displaying of the GUI can further include rendering a directional indicator associated with a direction from the second GUI element to the first GUI element. The determining the vehicle location can include obtaining a wireless handheld device location in response to the triggering signal and associating the vehicle location with the obtained wireless handheld device location. The determining the vehicle location can also include receiving a location signal from a GPS located in a vehicle navigational system in response to the triggering signal. The obtaining the wireless handheld device location can include receiving a location signal from a GPS located in at least one selected from a group of an accessory device and the wireless handheld device. The providing the map information can include obtaining the map information and storing the map information. The obtaining the map information can include downloading the map information from an Internet website. The wireless handheld device can be one selected from a group of a cellular phone, a pocket PC, a Smart phone, a PDA, and a BlackBerry™. The method can further include generating a triggering signal. The generated triggering signal can correspond to at least one selected from a group of a locking of the vehicle, a turning off an engine of the vehicle, and a setting a security system of the vehicle. The vehicle location can correspond to a GPS location where the vehicle is parked. The activating signal can correspond to at least one selected from a group of a pressing of one or more buttons on the wireless handheld device, a pressing of one or more buttons on an accessory device, and a launching of a software application on the wireless handheld device.

Computer program products, which may be embodied on computer readable-material, are also described. Such computer program products may include executable instructions that cause a computer system to conduct one or more of the method acts described herein. Similarly, computer systems are also described that may include one or more processors and a memory coupled to the one or more processors. The memory may encode one or more programs that cause the one or more processors to perform one or more of the method acts described herein. These general and specific implementations can be implemented using a system, a method, or a computer program, or any combination of systems, methods, and computer programs.

The subject matter described herein can provide one or more of the following advantages. Local maps can be generated and displayed automatically without changing the users' behavior. For example, when a user turns off the vehicle's ignition or locks the vehicle (e.g., with a key fob or manually locking the door), the location of the vehicle and the local map information associated with the vehicle's location can be automatically stored on the user's wireless handheld device (e.g., a cellular phone or PDA). Further, when the user wants the map to the vehicle or a local walking map of the area around the vehicle, one press of a button on the wireless handheld device can retrieve and display the map. Additionally, the user does not need to carry around any additional pieces of hardware that she does not already usually carry, such as, in some implementations, simply a wireless handheld device and, in other implementations, a wireless handheld device and a key fob.

Other aspects, features, and advantages will become apparent from the following detailed description, the drawings, and the claims.

### BRIEF DESCRIPTION OF THE DRAWINGS

FIG. 1A shows a schematic overview of an implementation configured to provide map information based on the location of a vehicle.

FIG. 1B shows a schematic overview of an alternative implementation configured to provide map information based on the location of a vehicle.

FIG. 2 shows a flow chart process for providing map information on a wireless handheld device based on a vehicle's location.

FIG. 3 shows a flow chart process for using the map information provided by the process of FIG. 2 to locate a vehicle.

FIG. 4A is a pictorial representation of one implementation configured to provide map information based on the location of a vehicle and to display a GUI based on the map information.

FIG. 4B shows one implementation of a graphical user interface (GUI) for locating a vehicle.

FIG. 5 is a pictorial representation of another implementation configured to provide map information based on the location of a vehicle.

Like reference symbols in the various drawings indicate like elements.

### DETAILED DESCRIPTION

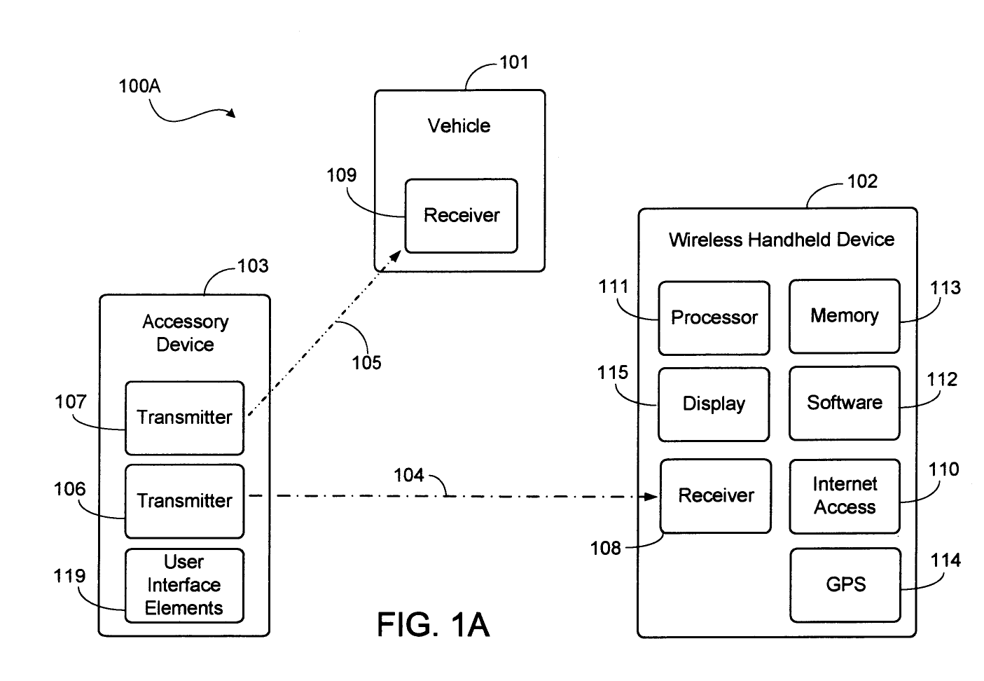

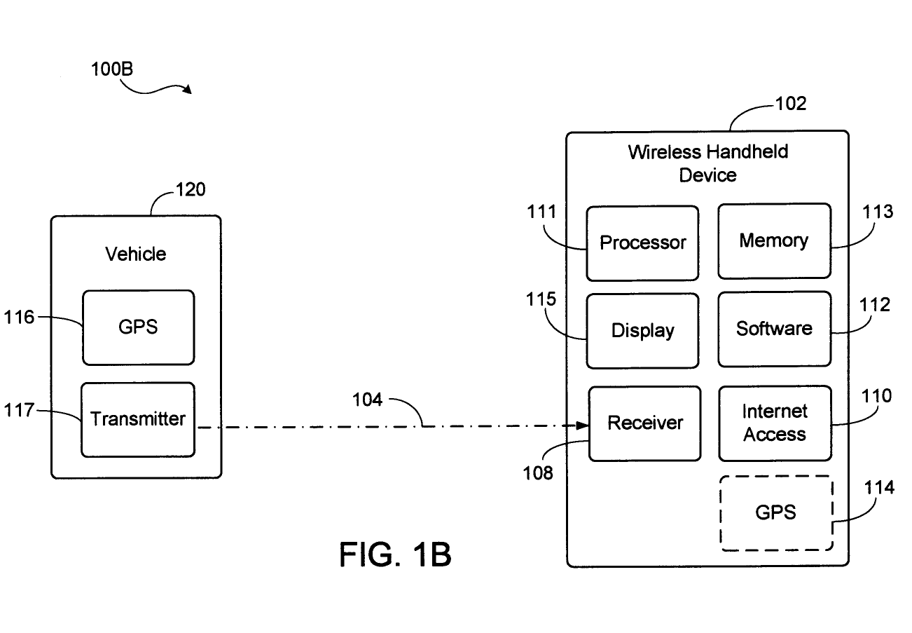

FIG. 1A shows a schematic overview of a system 100A that is configured to provide map information based on the location of a vehicle 101, such as a car, a truck, a motorcycle, a boat, a bicycle, or any other device capable of transporting a person. System 100A includes a wireless handheld device 102, such as a cellular phone, a personal digital assistant (PDA), a smart phone, a pocket PC, a Blackberry™, a Palm Treo™, or a portable handheld computer, which is configured to provide local maps to a user. The system 100A also includes an accessory device 103, such as a key fob typically used for remotely locking and unlocking a vehicle, such as the vehicle 101. The accessory device 103 is communicatively coupled to the wireless handheld device 102 via wireless link 104. The accessory device 103 is also communicatively coupled to the vehicle 101 via wireless link 105.

The accessory device 103 has a transmitter 106 for communicating with a receiver 108 of the wireless handheld device 102 via wireless link 104. The accessory device 103 also has a transmitter 107 for communicating with a receiver 109 of the vehicle 101 via wireless link 105. In other implementations, the transmitters 106, 107 can be fabricated as a single integrated transmitter. Additionally, the accessory device 103 has one or more user interface elements 119. Examples of user interface elements can include a lock button, an unlock button, a panic button, and an LED to indicate that the remote key fob is in communication with the vehicle.

The wireless handheld device 102 also has an Internet access module 110 for wireless connection to the Internet, one or more processors 111 configured to run a user interface application software 112, and a memory 113 for storing data, e.g., map information. In other implementations, the Internet access module 110 is optional because the wireless handheld device 102 can have map information pre-loaded in the memory 113. The memory 113 can be an on-board memory or a portable memory device such as a secure digital (SD), mini-SD, micro-SD, xD, CompactFlash or other similar types of memory storage devices typically supported by wireless handheld devices 102.

The wireless link 104 of the system 100A is a short-range wireless connection, such as a Bluetooth wireless connection. The wireless link 105 of the system 100A is implemented through a typical radio frequency link, which can result in better battery life preservation and longer operating range. However, the wireless links 104, 105 can be implemented in various other ways. For example, wireless link 104 can be implemented by using a typical radio frequency link, while wireless link 105 can be implemented by using the Bluetooth wireless protocol. In one implementation, one type of radio communication may be used to establish a communications link between the accessory device 103 and both the vehicle 101 and the wireless hand held device 102. In this variation, the transmitters 106 and 107 may be combined into a single transmitter, with an on-board processor (not shown) managing the communication links with the vehicle 101 and the wireless handheld device 102 through the same transmitter. Additionally, wireless link 104, 105 can also be implemented to adhere to any one of the WiFi communications standards based on the IEEE 802.11 specifications, or WiMAX communications standards based on the IEEE 802.16 specifications, or other wireless communications technologies, such as an infrared link (IrDA), wireless USB (WUSB) and the like.

The handheld device 102 further includes a GPS receiver 114 for generating location data of the handheld device 102, which can also be used to define or set the location of the vehicle. Instead of the GPS receiver 114, other means of determining location can be used; for example, a method of radiolocation (e.g., E911) using a trilateration between cellular base stations can be used. As shown in FIG. 1A, the GPS receiver 114 is integrated within the handheld device 102; optionally, the GPS receiver 114 can reside in an external GPS accessory device (not shown). When a user presses a button on the accessory device 103 to lock the vehicle 101, or set the alarm of the vehicle 101, via the wireless link 105 between the accessory device 103 and the vehicle 101, a locking or alarm setting signal is generated and transmitted from transmitter 107 to the receiver 109 of the vehicle 101, which in turn causes either the doors to lock and/or the alarm to be set. At the same time, a triggering or marking signal is generated by the accessory device 103, and transmitted by transmitter 106 to the receiver 108 of the wireless handheld device 102 via wireless link 104. The triggering signal subsequently causes GPS receiver 114 to obtain a location signal (e.g., location data) of the wireless handheld device 102, which is then used by user interface application software 112 to determine the vehicle location. In this implementation, determining the vehicle location is simply setting the location signal of the wireless handheld device 102 to be the vehicle location at the time a button is pressed on the accessory device 103 to lock the vehicle 101. The wireless handheld device 102 is assumed to be nearly or substantially co-located with the vehicle at the time the vehicle is locked; therefore the location of the wireless handheld device 102 is a good approximation of the parked location of the vehicle 102. The vehicle location is then stored in memory 113 and subsequently used by the user interface application software 112 as describe below.

The user may receive a confirmation signal from the user interface application software 112 indicating that the vehicle's location has been successfully saved. The user may then travel away from the vehicle, while carrying her wireless handheld device 102 and the accessory device 103. When the user desires to find her way from her current location back to the vehicle 101, she may activate the software application 112 on the wireless handheld device 102. The software application running on the wireless handheld device 102 can use the GPS receiver 114 to interactively track its own position by requesting frequent and periodic location signals from GPS satellites. This stream of interactively updated location signals of the wireless handheld device 102 can be used to provide a turn-by-turn, point-to-point directional map, and/or text-based directions, to guide the user from the current location of the handheld device 102 to the vehicle 101.

In one implementation, the software application 112 can be launched by navigating through native user input elements present on the wireless handheld device 102. In another implementation, the software application 112 can be launched by clicking a button on the accessory device 103, which sends a signal via the wireless link 104 between the accessory device 103 and the wireless handheld device 102, causing the software application 112 to be launched without requiring the user to navigate through the typically complex graphical user interface of the handheld device 102 to find the application. As shown in FIG. 1A, the GPS receiver 114 can be integrated in the wireless handheld device 102. Alternatively, the GPS receiver 114 can be implemented as an additional accessory device (not shown), such as a commercially available GPS receiver accessory device for the handheld device 102. This additional GPS receiver accessory device (not shown) is communicatively coupled with the handheld device 102 via a wireless link, implemented in any of the variety of ways used for the wireless link 104, and generally within close proximity to wireless handheld device 102. For example, in an implementation where the wireless link 104 is implemented as a Bluetooth link, a commercially available Bluetooth GPS receiver may be used in conjunction with the wireless handheld device 102 to obtain GPS location signals for use by the software application 112.

The user interface application software 112 generally interprets the location data generated by the GPS receiver 114 (which typically includes the stored vehicle location and the current, interactively updated location of the wireless handheld device 102). In one implementation, the user interface application software 112 also downloads map information based on the vehicle location by using the Internet access module 110 and provides a local map on a display 115, such as a liquid crystal display (LCD). In another implementation, the map data may have already been preloaded on the wireless handheld device 102, residing in its memory 113. The user interface application software 112 can be downloaded to the handheld device 102 via wireless or wired connectivity or it can be embedded in the handheld device 102 as firmware. An example of a method to deliver the user application software 112 from an object is described in Co-Pending U.S. patent application Ser. No. 11/519,455, the contents of which is incorporated in its entirety by reference. The user interface application software 112, however, can also be delivered to the wireless handheld device 102 via any of the standard methods for application installation. For example, the user interface application software 112 can be delivered over-the-air, or by synchronizing with content loaded on a personal computer (not shown).

Location data pertaining to the current location of the wireless handheld device 102 provided by the GPS receiver 114 is used by the user interface application software 112 to show on the display 115 the current location of the hand-held device 102 relative to the vehicle location. For example, the user interface application software 112 can provide a graphical user interface (GUI) on the display 115 and associate and render the vehicle location with a first GUI element (e.g., a graphical representation of a vehicle) and the current location of the wireless handheld device 102 with a second GUI element (e.g., a figure of a person). Thus, the user interface application software 112 receives the vehicle location provided by the GPS receiver 114 (which is simply the location of the handheld device 102 at the time the triggering or marking signal is generated), interprets the vehicle location, and either stores this information with maps which have been previously stored in the wireless handheld device 102's memory 113, or optionally downloads map information using the vehicle data and stores the downloaded map information in the memory 113.

FIG. 1B shows a schematic overview of another system 100B that is also configured to provide map information based on the location of a vehicle 120. System 100B includes a wireless handheld device 102, as discussed in detail with respect to FIG. 1A. However, an accessory device, such as a key fob, is not used in the system 100B, given the vehicle 101 in system 100B has a GPS receiver 116, such as a navigational system with an embedded GPS chip and associated circuitry and software, for obtaining and interpreting GPS location data of the vehicle 101 (i.e., the vehicle location), and a transmitter 117 for transmitting such location data to the receiver 108 of the wireless handheld device 102 via the wireless link 104. For example, when a user manually or wireless locks the vehicle 101, sets an alarm system of the vehicle 101 (if it has one), or turns off the engine of 101, a triggering or marking signal is generated (and received), which causes the GPS receiver 116 in the vehicle 120 to obtain the location signal (location data) of the vehicle 120.

The location signal of the vehicle 120 is then transmitted by transmitter 117 to the receiver 108 of the wireless handheld device 102 via wireless link 104, and is then stored in memory 113 and used by the user interface application software 112 as previously described. Unlike other systems where the GPS location signal may take several minutes to update, a car navigation system with GPS inside generally maintains up-to-date location of the vehicle at all times. Therefore, in this implementation, the marking and storing of the car location data to the wireless handheld device 102 can be both transparent and instantaneous. No change in the user's normal behavior in parking and locking the vehicle would be required; the act of locking the vehicle can instantly send the parked location of the vehicle to the hand held device 102, with no perceived latency.

The wireless handheld device 102 can optionally include a GPS receiver 114 for generating location data of the handheld device 102. As discussed previously with respect to FIG. 1A, with the optional GPS 114, the position of the wireless handheld device 102 can be tracked and the location data can be used to provide a turn-by-turn, point-to-point directional map (or text-based directions) from the current location of the handheld device 102 to the marked location of the vehicle 120. The optional GPS 114 can be integrated in the handheld device 102 (as shown) or can be implemented using an additional accessory device (not shown), such as a commercially available GPS receiver accessory device, that is communicatively coupled with the handheld device 102 via a wireless communication link, similar to the implementation of wireless link 104 between the vehicle and the wireless handheld device.

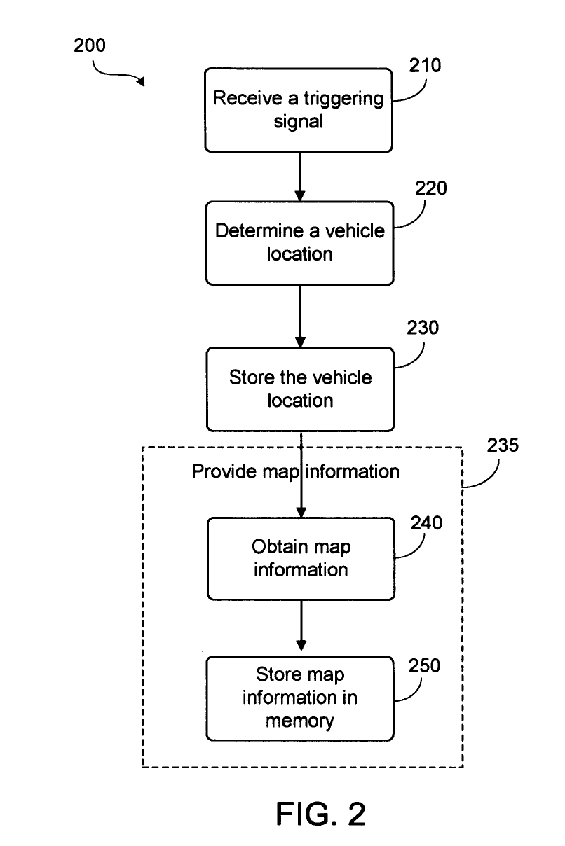

FIG. 2 shows a flow chart process 200 for providing map information based on the vehicle location. Initially, a user turns on the wireless handheld device, such as the wireless handheld device 102 shown in FIGS. 1A & 1B, if it is not already on. Additionally, a user also turns on the accessory device, such as the accessory device 103 shown in FIG. 1A, if it is not already on, but typically the accessory device will always be on unless the battery in the accessory device is out of power. Further, if an external GPS receiver accessory device is used, then this device would be turned on as well, and the user would wait for confirmation from the device that GPS signals are being received by the external GPS receiver accessory device. At 210, a triggering (or marking) signal is received. In the implementation of FIG. 1A, the wireless handheld device 102 receives the triggering signal. In one variation, the triggering signal can be generated by another device, such as accessory device 103 of FIG. 1A, via actuation of a user input element 119 such as a button on accessory device 103 of FIG. 1A to lock or arm an alarm on the vehicle 101. In another implementation, as illustrated in FIG. 1B, the vehicle generates the triggering signal upon being locked or armed with an alarm, and this signal is received by the GPS receiver on board the vehicle 120 in FIG. 1B. In both cases, the triggering signal can be generated when the user remotely or manually locks the vehicle, enables an alarm or security system of the vehicle, or turns off the engine of the vehicle. Thus, the wireless handheld device or the vehicle is typically in close proximity with the source of the triggering signal when the triggering signal is received.

At 220, the vehicle location is then determined. In one implementation, as illustrated in FIG. 1A where the GPS receiver 114 is integrated within the wireless handheld device 102, the wireless handheld device determines the vehicle's location based on a location signal, such as a GPS signal. In another implementation, as illustrated in FIG. 1A where the GPS receiver is located in an external GPS receiver accessory device, the signal is captured by the external device and communicated back to the wireless handheld device 102 via a wireless link. In a third implementation, as illustrated in FIG. 1B, the location signal can be generated or obtained either by the GPS receiver 116 on board the vehicle (e.g., if the vehicle has a GPS as in system 100B) or by the handheld device (e.g., if the handheld device has a GPS receiver 114 as in one variation of system 100B). In the case where the wireless handheld device or a GPS accessory generates or obtains the location signal in response to a triggering signal (e.g., system 100A), the vehicle location is determined to be (i.e., associated with) that location signal, i.e., the GPS location of the wireless handheld device or the GPS accessory at the time the triggering signal was received. On the other hand, in the case where the vehicle's on board GPS unit 116 generates the location signal in response to a triggering signal (e.g., system 100B), the vehicle location is determined to be (i.e., corresponds to) the vehicle's GPS location signal, i.e., the GPS location of the vehicle (e.g., where the vehicle is parked) at the time the triggering signal was received.

At 230, the wireless handheld device stores the vehicle location, such as memory 113, so that it can be used later by the user interface application software 112 or other software or firmware applications resident on the wireless handheld device. At 235, map information is generated via commercially available mapping databases and provided based on the stored vehicle location. At 240, map information is obtained based on the vehicle location, such as by downloading the map information based on the vehicle location from Internet websites (e.g., Google™ Maps and Mapquest™) using the wireless handheld device's Internet access module, or by accessing pre-stored map information contained in the wireless handheld device's memory. Next, at 250, the obtained map information is stored in memory, such as memory 113 of the wireless handheld device 102. Thus, map information based on the vehicle location is automatically provided by the wireless handheld device upon a triggering event, such as locking the vehicle and turning off the vehicle's engine, without changing the user's behavior. A local map based on the map information can then be displayed, e.g., when the user presses a button on the wireless hand held device or opens the wireless hand-held device if it has a clam-shell form factor, and then used to get to the user's final destination (e.g., such as when a user travels on foot from a parking garage to an office building). In the implementation described in FIG. 1A, where an accessory device 103 is used, the local map may also be optionally displayed by pressing a button on the accessory device 103 to launch the interactive map on the wireless handheld device 102. This alternative method of launching the map offers a one-button interaction model which can result in a smooth and transparent user experience.

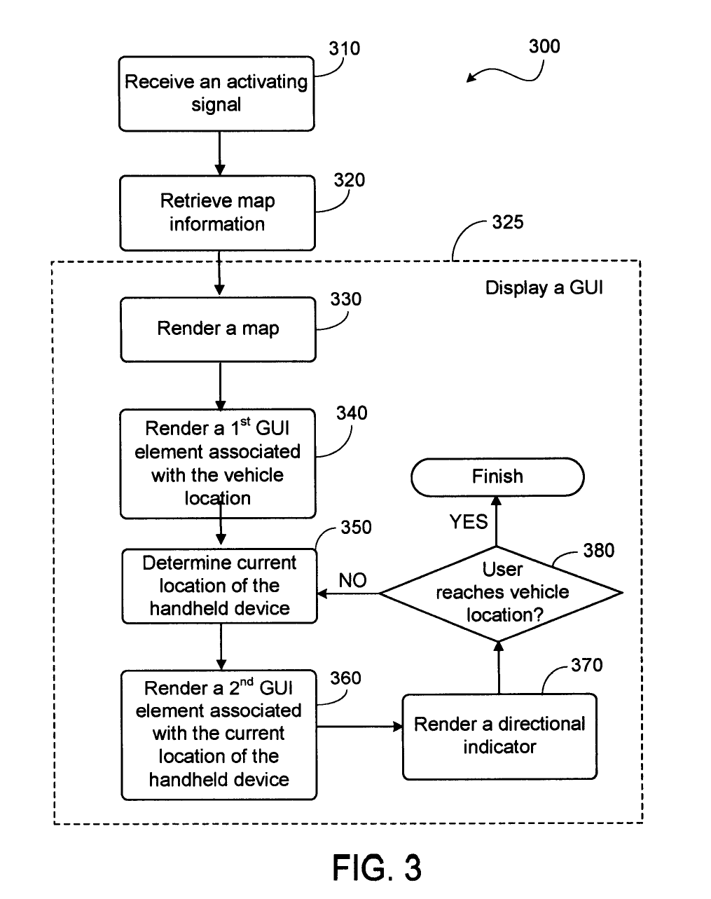

FIG. 3 shows a flow chart process 300 for using the stored map information provided by process 200 to locate a vehicle. At 310, an activating signal is received by, e.g., the wireless handheld device. The activating signal can be generated by pressing a button or a shortcut key on the wireless handheld device (which in that case it generates and receives the activating signal) or the accessory device (if used), or selecting a software application on the handheld device (which again in that case it generates and receives the activating signal). At 320, in response to the activating signal, the stored map information from process 200 is retrieved, such as from the memory 113 of the wireless handheld device 102. At 325, the wireless handheld device displays a graphical user interface (GUI). The GUI can include a rendered map based on the retrieved map information and rendered GUI elements, which can be accomplished as reflected at 330, 340, 340, 360, 370 and 380. The GUI provides a navigational system to the user and allows the user to zoom and pan the rendered map.

At 330, a map is rendered based on the retrieved map information. The rendered map includes the vehicle location given the retrieved map information is based on the vehicle location. Additionally, if the map information was originally downloaded from Internet websites, then a location marker (e.g., a star symbol) will typically be included on the rendered map to denote the vehicle location, which was used to query the Internet website to obtain the map information. However, if a location marker of the vehicle location is not provided as part of the map information or the particular representation of the location market is not desirable, then another location marker can be provided to represent the vehicle location on the rendered map, and therefore at 340, a first GUI element (i.e., a location marker) associated with the vehicle location is rendered; otherwise step 340 may be skipped. In the case that a location marker has been included in the downloaded map information, rendering the first GUI element can simply mean superimposing a new location marker (e.g., a car symbol) on top of the original location marker. This map can be rendered in the “North up” orientation, where the map is typically displayed so that the direction “North” is aligned with the vertical direction of the display on the wireless handheld device as viewed by the user. The map can also be rendered so that directional data is used to determine an orientation of the user as she proceeds towards the target stored location; the map can then be rotated such that the forward direction of the user is aligned with the vertical direction of the display, which is a feature often seen in commercial car GPS navigation systems.

Next, at 350, a current location of the wireless handheld device is determined based on a GPS location of the handheld device, which may be provided by GPS receiver 114. The GPS location can also be provided by an external GPS accessory device in communication and close proximity with the wireless handheld device. At 360, a second GUI element associated with the current location of the wireless handheld device is rendered. For example, the second GUI element can be a symbol of a person, a marker denoting “Me” or some other icon or symbol denoting the locating of the wireless handheld device or GPS accessory. At 370, a directional indicator between the first GUI element and the second GUI element can optionally be rendered to assist a user in locating her vehicle denoted as the first GUI element (or original location marker). The directional indicator can be an arrow associated with the direction from the second GUI element (e.g., the current wireless handheld device or GPS accessory location) to the first GUI element (e.g., the vehicle location).

At 380, a determination is made as to whether the user has reached the retrieved vehicle location within a predetermined distance. If the user has not reached the retrieved vehicle location within the predetermined distance, then at 350, a new current location of the wireless handheld device (or GPS accessory) is determined and then at 360 the second GUI element is rendered and reflected on the rendered map at the new current location. Further, at 370, an updated directional indicator will also result based on the updated location of the handheld device. Thus, the GUI can provide turn-by-turn or point-to-point directions to the user as the user finds her way back to her vehicle. In another implementation, in lieu of or in conjunction with a directional indicator pointing from the current location of the hand held device to the stored location of the parked vehicle, a route planner may be included in the software application, which plans a walking or driving route from the user's current position to the stored location of the vehicle. This route may follow turns on side streets and may respect buildings or other structures in the map database which may prevent the user from walking in a straight line from their current position to the location of the parked vehicle. Thus, the GUI (which has the rendered map and additional first and second GUI elements and directional indicator, and optionally a highlighted walking or driving route) can assist users who forget where they parked their vehicles, for example, in a large parking lot or on a city street. In this case, the GUI can be accessed whenever the user desires by pressing a button or a key on the wireless handheld device or the accessory device (if used); or selecting an application on the wireless handheld device.

In general, route finding between any two points that can be marked with a GPS location signal can be achieved. In an implementation such as FIG. 1A, where a GPS receiver 114 is either integrated with the handheld device 102 or available in an external GPS accessory device (not shown), the marked location does not need to be that of a parked vehicle. The user may use this application to mark a starting location anywhere, and use the software to help them navigate their way back to this starting location with turn by turn directions. Alternatively, the user may manually enter the destination as an address string using conventional input technologies available on a wireless handheld device, and then use the software application 112 to help them find their way from their current location to their desired destination.

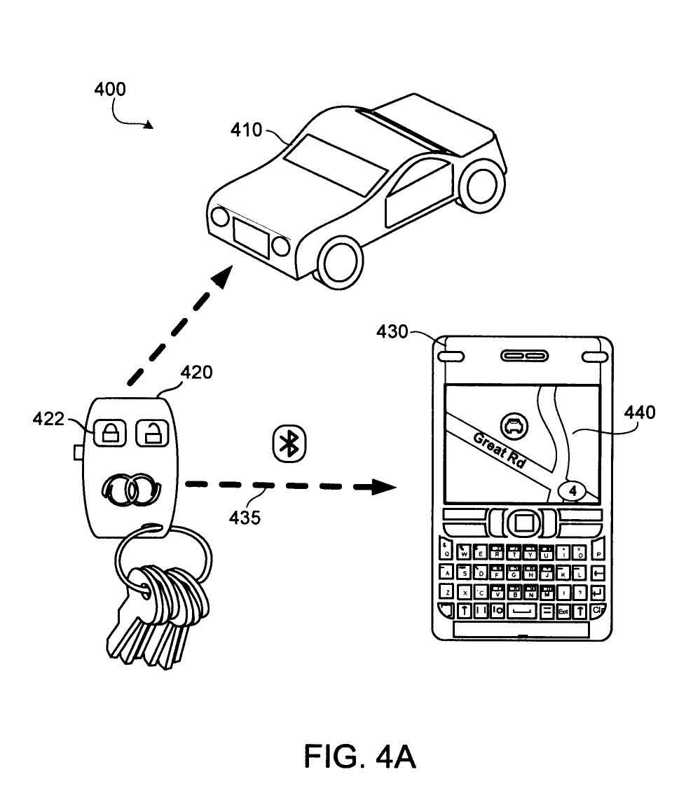

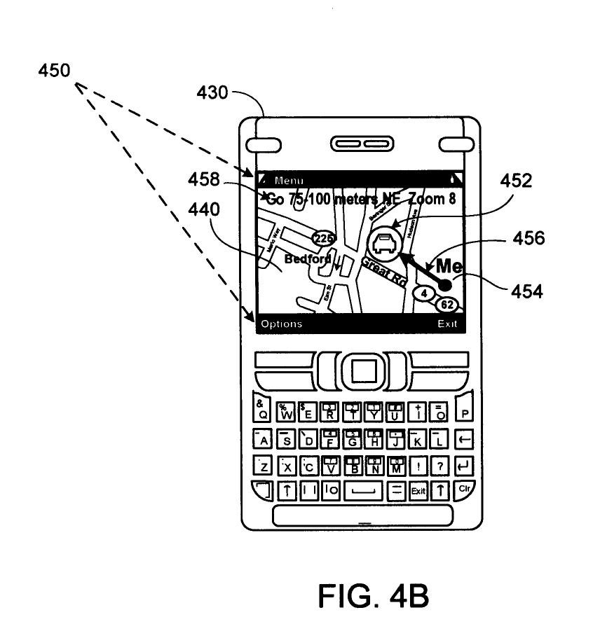

FIG. 4A is a pictorial representation of one implementation of a system 400 configured to provide map information based on the location of a vehicle 410 and to display a GUI based on the map information. System 400 includes a key fob 420 and a wireless hand-held device, such as a cellular phone 430. The key fob 420 is a Bluetooth enabled remote locking/unlocking device for the vehicle 410. The cellular phone 430 is Bluetooth enabled and has GPS capability. When the lock button 422 is pressed on the key fob 420, a radio frequency signal is transmitted to the vehicle 410 to lock the doors of the vehicle 410. In addition, a triggering signal is sent from the key fob 420 to the cellular phone 430 via Bluetooth wireless link 435.

Upon receiving the triggering signal from the key fob 420, a software application on the cellular phone 430 is launched to determine the location of the vehicle 410 (i.e., vehicle location) based on the GPS location of the cellular phone 430. In this implementation, the software application determines that the location of the vehicle 410 is the GPS location of the cellular phone 430. That is, the software application associates the vehicle location with the GPS location of the cellular phone 430. The software application further automatically downloads map information based on the vehicle location and stores the downloaded map information in memory of the cellular phone 430. The cellular phone 430 then renders and displays a local map 440 based on the downloaded map information, in response to an activating signal, such as one that can be generated from the press of a button or a shortcut key on the cellular phone 430, or from pressing a button on the key fob 420 to launch the map.

The marking or triggering process is automatic once the user causes a triggering signal to be generated, and can typically occur while the user is getting out of the vehicle 410 or after getting out and locking the vehicle. The display process for the map can optionally be coupled to the marking or triggering process. If the triggering process and display process are combined, at the discretion of the user in their preferences settings for the software application, the user can then immediately view the local map 440 in a GUI, which includes the local map 440 rendered based on the map information 440 and a symbol of the location of the vehicle 410, if not provided as part of the map information. The local map 440 can be useful for walking directions in the vicinity of the car, or for keeping track of where the user's vehicle is parked. If the user subsequently forgets the location of the vehicle 410, the user can get directions on the cellular phone 430 by retrieving the local map 440.

FIG. 4B shows one implementation for a graphical user interface (GUI) 450 for locating a vehicle using cellular phone 430. The GUI 450 includes the local map 440, which is generated by a user interface software application of the cellular phone 430 based on the stored map information that is obtained based on the location of the vehicle 410. The GUI 450 can include various GUI elements. For example, a first GUI element 452 (e.g., a graphical representation of a car) can be associated with the stored location of the vehicle 410. Further, a second GUI element 454 (e.g., a marker denoting “Me”) can be associated with the current location of the cellular phone 430, which is determined based on the GPS location of the cellular phone 430. Additionally, the GUI 450 can include directional indicators 456, 458 to assist a user in locating the vehicle 410. The directional indicator can be an arrow 456, which graphically points to the direction of the vehicle 410 as represented by the first GUI element 452, or a text message 458, which instructs the user with a walking direction. Additionally, a walking or driving route may optionally be generated by the software and superimposed on top of the other elements already present in the GUI to indicate a recommended route for the user to travel from their current location to their parked vehicle.

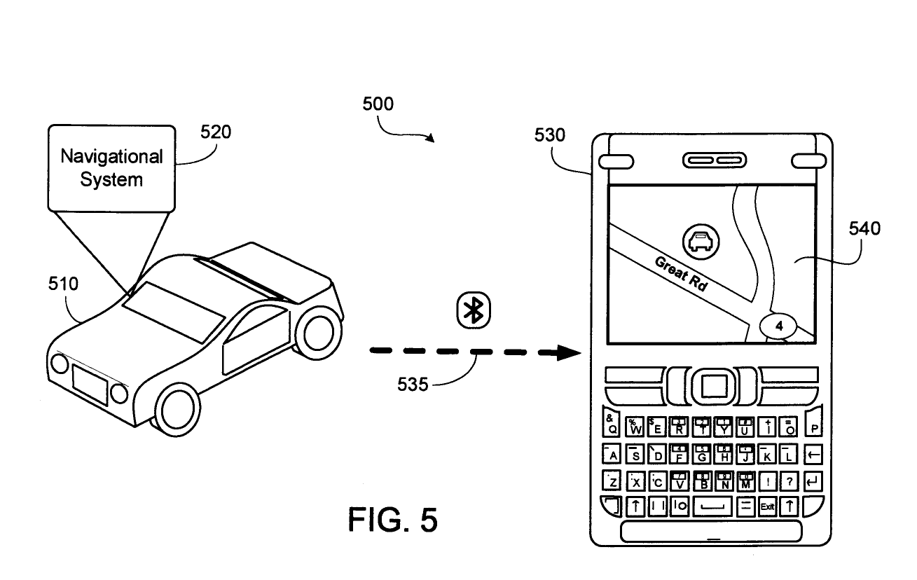

FIG. 5 is a pictorial representation of another implementation of a system 500 configured to provide and display a local map based on the location of a vehicle 510. As shown in FIG. 5, system 500 includes a navigational system 520 with GPS capability for the vehicle 510 and a cellular phone 530. Both the navigational system 520 and the cellular phone 530 are Bluetooth enabled. The cellular phone 530 is communicatively coupled with the navigational system 520 via Bluetooth wireless link 535. The navigational system 520 receives a triggering signal from the vehicle 510 indicating when the vehicle 510 has been turned off, when it has been locked, or when its alarm system has been activated. In response to the triggering signal, the navigational system 520 sends the GPS location data of the vehicle 510 to the cellular phone 530 via Bluetooth wireless link 535. The cellular phone 530 can then download map information via the Internet based on the GPS location of the vehicle 510, or it may retrieve map information from its memory. Once the map information is stored in the memory of the cellular phone 530, a local map 540 can be generated and displayed on the cellular phone 530.

If the trigger signal for the marking of the vehicle location and the trigger signal for launching the map are combined, the displaying of the local map 540 on the cellular phone 530 can be done automatically and is perceived by the user as immediate because it can be done while the user is getting out of the vehicle 510. By the time the user exits the vehicle 510, the user can see the local map 540 including the location of the vehicle 510. The local map 540 can be useful for walking directions in the vicinity of the car or for keeping track of where the user's vehicle is parked. If the user subsequently forgets the location of the vehicle 510, the user can get directions on the handheld device 530 by launching a software application. Implementation 500 does not require the cellular phone 530 to be GPS enabled since the location of the vehicle 510 is transmitted by the navigational system 520. Local maps based on the location of the vehicle 510 can be downloaded via the Internet retrieved from the handheld device's memory without having GPS capability on the cellular phone 530. Alternatively, cellular phone 530 can be GPS enabled to allow the extra feature of providing point-to-point walking directions, similar to the GUI 450 shown in FIG. 4B.

Various implementations of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “memory” comprises a “computer-readable medium” that includes any computer program product, apparatus and/or device (e.g., magnetic discs, optical disks, RAM, ROM, registers, cache, flash memory, and Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Although a few variations have been described in detail above, other modifications are possible. For example, instead of the GPS receiver, other means of determining location can be used to provide location data; for instance, a method of radiolocation (e.g., E911) using a trilateration between cellular base stations can be used. Accordingly, other implementations are within the scope of the following claims. For example, the actions recited in the claims can be performed in a different order and still achieve desirable results.

What is claimed is:

1. A method of providing a map on a wireless handheld device, the method comprising:
receiving a triggering signal;
determining a vehicle location in response to the triggering signal;
storing the vehicle location; and
providing map information based on the stored vehicle location.

2. The method of claim 1, further comprising:
receiving an activating signal;
retrieving the map information in response to the activating signal; and
displaying a graphical user interface (GUI).

3. The method of claim 2, wherein displaying the GUT comprises:
rendering a map based on the map information; and
rendering a first GUT element associated with the stored vehicle location.

4. The method of claim 3, wherein displaying the GUI further comprises:
determining a current location of the wireless handheld device; and
rendering a second GUI element associated with the determined current location.

5. The method of claim 4, wherein displaying the GUI further comprises:
rendering a directional indicator associated with a direction from the second GUT element to the first GUT element.

6. The method of claim 1, wherein determining the vehicle location comprises:
obtaining a wireless handheld device location in response to the triggering signal; and
associating the vehicle location with the obtained wireless handheld device location.

7. The method of claim 6, wherein obtaining the wireless handheld device location comprises receiving a location signal from a GPS located in at least one selected from a group of an accessory device and the wireless handheld device.

8. The method of claim 1, wherein determining the vehicle location comprises receiving a location signal from a GPS located in a vehicle navigational system in response to the triggering signal.

9. The method of claim 1, wherein providing the map information based on the stored vehicle location comprises:
obtaining the map information; and
storing the map information.

10. The method of claim 9, wherein obtaining the map information comprises downloading the map information from an Internet website.

11. The method of claim 1, wherein the wireless handheld device is one selected from a group of a cellular phone, a pocket PC, a Smart phone, a PDA, and a BlackBerry™.

12. The method of claim 1, further comprising generating a triggering signal, wherein the generated triggering signal corresponds to at least one selected from a group of a locking of the vehicle, a turning off an engine of the vehicle, and a setting a security system of the vehicle.

13. The method of claim 1, wherein the vehicle location corresponds to a GPS location where the vehicle is parked.

14. The method of claim 2, wherein the activating signal corresponds to at least one selected from a group of a pressing of one or more buttons on the wireless handheld device, a pressing of one or more buttons on an accessory device, and a launching of a software application on the wireless handheld device.

15. A method of locating a vehicle using a wireless handheld device, the method comprising:
receiving a triggering signal;
determining a vehicle location in response to the triggering signal;
storing the vehicle location in memory;
providing map information based on the stored vehicle location;
receiving an activating signal;
retrieving the map information in response to the activating signal; and
displaying a graphical user interface (GUI) based on the map information.

16. The method of claim 15, wherein displaying the GUI comprises
rendering a map based on the map information.

17. The method of claim 16, wherein displaying the GUI further comprises:
associating a first GUI element with the stored vehicle location; and
rendering the associated first GUI element.

18. The method of claim 17, wherein displaying the GUI further comprises:
determining a current location of the wireless handheld device;
associating a second GUI element with the current location; and
rendering the associated second GUI element.

19. The method of claim 18, wherein displaying the GUI further comprises:
associating a directional indicator with a direction from the rendered second GUI element to the rendered first GUI element; and
rendering the directional indicator.

20. The method of claim 15, further comprising generating a triggering signal, wherein the generated triggering signal corresponds to at least one selected from a group of a locking of the vehicle, a turning off an engine of the vehicle, and a setting a security system of the vehicle.

21. The method of claim 15, wherein the vehicle location corresponds to a GPS location where the vehicle is parked.

22. The method of claim 15, wherein the activating signal corresponds to at least one selected from a group of a pressing of one or more buttons on the wireless handheld device, a pressing of one or more buttons on an accessory device, and a launching of a software application on the wireless handheld device.

23. A computer program product, embodied on a computer readable-material, the computer program product comprising executable instructions causing a data processing apparatus to:
receive a triggering signal;
determine a vehicle location in response to the triggering signal;
store the vehicle location; and
provide map information based on the stored vehicle location.

24. The computer program product as in claim 23, further comprising executable instructions causing a data processing apparatus to:
receive an activating signal;
retrieve the map information in response to the activating signal; and
display a graphical user interface (GUI) based on the map information.

25. The computer program product as in claim 24, wherein the executable instruction causing the data processing apparatus to display the GUI based on the map information comprises executable instructions causing a data processing apparatus to:
render a map based on the map information;
associate a first GUI element with the stored vehicle location; and
render the associated first GUI element.

26. The computer program product as in claim 25, wherein the executable instruction causing the data processing apparatus to display the GUI based on the map information further comprises executable instructions causing a data processing apparatus to:
determine a current location of the wireless handheld device;
associate a second GUI element with the current location; and
render the associated second GUI element.

27. The computer program product as in claim 26, wherein the executable instruction causing the data processing apparatus to display the GUI based on the map information further comprises executable instructions causing a data processing apparatus to:
associate a directional indicator with a direction from the rendered second GUI element to the rendered first GUI element; and
render the associated directional indicator.

28. The computer program product as in claim 23, further comprising executable instructions causing a data processing apparatus to generate a triggering signal, wherein the generated triggering signal corresponds to at least one selected from a group of a locking of the vehicle, a turning off an engine of the vehicle, and an enabling a security system of the vehicle.

29. The computer program product as in claim 23, wherein the vehicle location corresponds to a GPS location where the vehicle is parked.

30. The computer program product as in claim 24, wherein the activating signal corresponds to at least one selected from a group of a pressing of one or more buttons on the wireless handheld device, a pressing of one or more buttons on an accessory device, and a launching of a software application on the wireless handheld device.

31. A system for providing a map associated with a vehicle location, the system comprising:
a wireless handheld device including a computer readable medium;
a computer program product stored on the computer readable medium, the stored computer program product including executable instructions causing the wireless handheld device to:
receive a triggering signal;
determine the vehicle location in response to the triggering signal;
store the vehicle location; and
provide map information based on the stored vehicle location.

32. The system of claim 31, wherein the executable instructions further including instructions causing the wireless handheld device to:
receive an activating signal;
retrieve the map information in response to the activating signal; and
display a graphical user interface (GUI) based on the map information.

33. The system of claim 32, wherein the executable instruction causing the wireless handheld device to display the GUI based on the map information comprises instructions causing the wireless handheld device to:
render a map based on the map information; and
render a first GUI element associated with the stored vehicle location.

34. The system of claim 33, wherein the executable instructions causing the wireless handheld device to display the GUI based on the map information further comprises instructions causing the wireless handheld device to:
determine a current location of the wireless handheld device; and
render a second GUI element associated with the current location.

35. The system of claim 34, wherein the executable instructions causing the wireless handheld device to display the GUI based on the map information further comprises instructions causing the wireless handheld device to:
render a directional indicator associated with a direction from the second GUI element to the first GUI element.

36. The system of claim 31, wherein the vehicle location corresponds to a GPS location where the vehicle is parked.
